(19) United States
(12) Patent Application Publication
(10) Pub. No.: US 2004/0199528 A1
(43) Pub. Date: Oct. 7, 2004

(54) Apparatus and computer program for managing database

(75) Inventors: Kazuo Kayamoto, Yokohama (JP); Hideyuki Kakutani, Yokohama (JP); Toru Yoshibayashi, Kawasaki (JP); Kenichiro Miyamoto, Oita (JP); Hirofumi Okamoto, Yokohama (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/766,967

(22) Filed: Jan. 28, 2004

(30) Foreign Application Priority Data
Feb. 20, 2003 (JP) 2003-043101

(51) Int. Cl. G06F 7/00

(52) U.S. Cl. 707/100

(57) ABSTRACT

An apparatus for and a computer program for managing a database, which performs a search of data from a database based on predetermined information selected by a user from among information registered as a dictionary, includes a personal dictionary registering unit that registers information on either of or both management and analysis of the data stored in the database to the dictionary as a personal dictionary that is accessible only by a predetermined user, and a dictionary reference unit that outputs the information registered in the dictionary including the information registered as the personal dictionary, and accepts a selection of the predetermined information by the user from among the information output.

### BACKGROUND OF THE INVENTION

1) Field of the Invention

The present invention relates to a technology for managing database that allows a user to freely manipulate a data dictionary to efficiently retrieve data from the database.

2) Description of the Related Art

A database containing various data and a database management apparatus are currently in use, from which a user can extract useful information by processing and searching desired data. The database management apparatus generally employs a dictionary (also called a data dictionary) that stores information required for managing the database, as described in, for example, Michael J. Corey, and Michael Abbey, “ORACLE Data Warehousing”, First Edition, SE Editorial Translation Department, Shoeisha Inc., p.49, November 1997.

Information such as structure and attributes of the data stored in the database are registered in the dictionary, and the database is searched by referring to the dictionary. Further, information concerning data analysis such as classification of the data can be stored in the dictionary, and when the user searches the database, data can also be searched by referring to the information for the data analysis.

In the conventional technology, since a plurality of users use a common dictionary, a user is not allowed to freely update information in the dictionary. In other words, if a user updates information when another user queries the database by using the information in the dictionary, the second user can no longer get a result from the database.

In order to avoid such problem, it is possible to keep any user from performing a free modification of the dictionary, and allow only an administrator to update the dictionary based on each of the users. In this case, however, a burden on the administrator increases as the number of users increases. Particularly, when a user wants to store data concerning the data analysis, it takes a considerable time to update the dictionary by requesting the administrator, resulting in a low efficiency of the data analysis.

Alternatively, an exclusive access control of locking the dictionary when a user updates the dictionary can be employed. However, when many users frequently register the information on the data analysis to the dictionary, it causes the dictionary locked frequently and updating the dictionary cannot be performed with ease.

### SUMMARY OF THE INVENTION

It is an object of the present invention to solve at least the problems in the conventional technology.

The database management apparatus that performs a search of data from a database based on predetermined information selected by a user from among information registered as a dictionary, according to one aspect of the present invention, includes a personal dictionary registering unit that registers information on either of or both management and analysis of the data stored in the database to the dictionary as a personal dictionary that is accessible only by a predetermined user, and a dictionary reference unit that outputs the information registered in the dictionary including the information registered as the personal dictionary, and accepts a selection of the predetermined information by the user from among the information output.

The database management method to perform a search of data from a database based on predetermined information selected by a user from among information registered as a dictionary, according to another aspect of the present invention, includes registering information on either of or both management and analysis of the data stored in the database to the dictionary as a personal dictionary that is accessible only by a predetermined user, outputting the information registered in the dictionary including the information registered as the personal dictionary, and acceptting a selection of the predetermined information by the user from among the information output.

The computer program for managing a database to perform a search of data from a database based on predetermined information selected by a user from among information registered as a dictionary, according to still another aspect of the present invention, makes a computer execute the method according to the present invention.

The computer-readable recording medium for storing a computer program for realizing a database management, according to still another aspect of the present invention, stores the computer program according to the present invention.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram for illustrating a functional configuration of a database management apparatus according to an embodiment of the present invention;

FIG. 2 is an example of a table structure of a common table and a personal table in a database;

FIG. 3 is an example of a data structure of a common dictionary and a personal dictionary in a data dictionary;

FIG. 4 is a flowchart of a procedure of database search according to the embodiment;

FIG. 5 is an example of a display screen when storing a search result as a personal table;

FIG. 6 is an example of a display screen when “Export to table” menu shown in FIG. 5 is selected;

FIG. 7 is a flowchart of a procedure of registering information in the personal table to the personal dictionary shown in FIG. 4;

FIG. 8 is an example of a display screen when registering operation data to the personal dictionary;

FIG. 9 is a flowchart of a procedure of storing data having a predetermined file format to the personal table;

FIG. 10 is an example of a display screen when storing the data having the predetermined file format to the personal table;

FIG. 11 is an example of a display screen when “Store data” menu shown in FIG. 10 is selected; and

FIG. 12 is a block diagram for illustrating a hardware configuration of the database management apparatus.

### DETAILED DESCRIPTION

Exemplary embodiments of an apparatus and a computer program for managing a database according to the present invention are explained in detail with reference to the accompanying drawings.

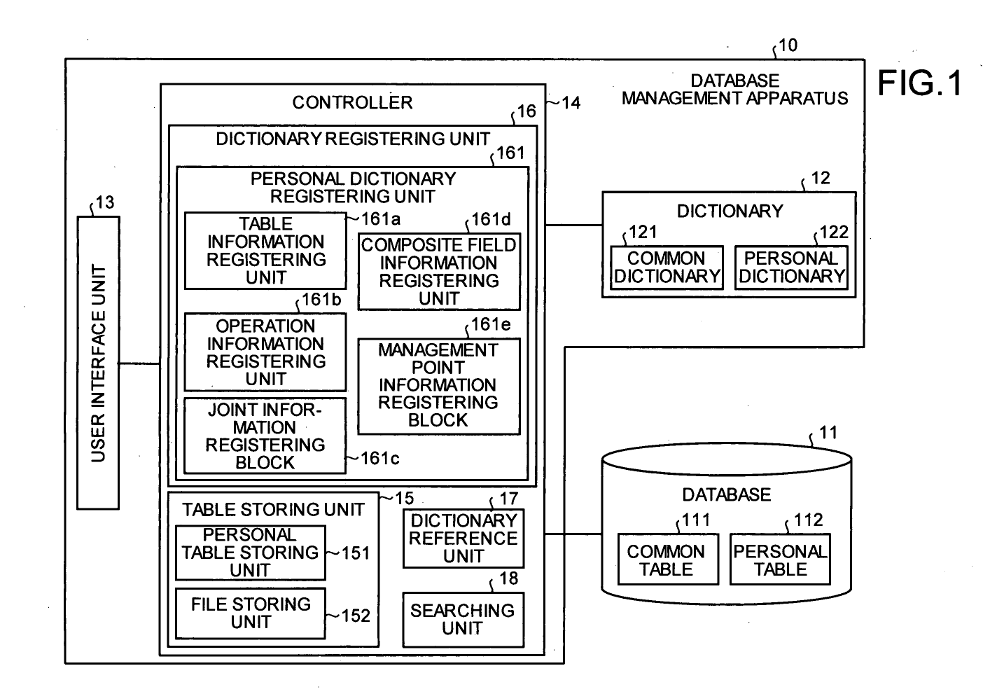

FIG. 1 is a block diagram for illustrating a functional configuration of a database management apparatus according to an embodiment of the present invention. The database management apparatus 10 includes a dictionary 12, a user interface unit 13, and a controller 14, and is linked to a database 11. The dictionary 12 includes a personal dictionary 122 in which a user can enter or update information freely. The database management apparatus 10 carries out efficient data search on the database 11 by using the personal dictionary 122 and a common dictionary 121 which is accessible by all the users.

The database 11 is a relational database which is a collection of table data that are managed by tables. The database 11 comprises a common table 111 and a personal table 112. The common table 111 is accessible by all the users, while the personal table 112 is built by the data entered into the database 11 by each user.

The dictionary 12 stores the data concerning the management and analysis of the tables included in the database 11. More specifically, the dictionary 12 stores information pertaining to the structure, attribute, etc. of each table in the form of schemas, and also stores information about the method of analysis of the stored tables.

The common dictionary 121 is accessible by all the users for reference, and stores data concerning the management and analysis of the common table 111. The personal dictionary 122 is a dictionary in which only an authorized user can enter information into, refer to, and update information, and stores data concerning the management and analysis of the common table 111 and the created personal table 112.

The user interface unit 13 controls the input/output between the user and the database management apparatus 10. More specifically, the user interface unit 13 receives the input from a user made through SQL or through a GUI (graphical user interface) via a window screen, and requests the searching unit 18 to search data. When the user interface unit 13 receives input through GUI, it is dynamically converted into SQL. Further, when the user interface unit 13 receives a request for referring to the dictionary 12 from the user, the user interface unit 13 requests a dictionary reference unit 17 to refer to the dictionary 12, and outputs information stored in the common dictionary 121 or the personal dictionary 122 for the benefit of the user.

Moreover, the user interface unit 13 accepts from the user the specification of a layout in which the search result which is to be output when data is retrieved from the database 11. More specifically, the user interface unit 13 receives the specification regarding the table format data to be presented as the search result. When accepting the layout specification, the user interface unit 13 displays the information stored in the common dictionary 121 and the personal dictionary 122 and allows the user to select information required for the data search.

The controller 14 carries out the overall control of the database management apparatus 10, and includes a table storing unit 15, a dictionary storing unit 16, the dictionary reference unit 17, and a searching unit 18. The table storing unit 15 stores the common table 111 or the personal table 112 in the database 11. Each user can freely enter data in the personal table 112.

The table storing unit 15 includes a personal table storing unit 151 and a file storing unit 152. The personal table storing unit 151 stores as the personal table 112 the table format data presented as the search result. The file storing unit 152 stores as the personal table 112 of the table format data which includes predetermined file formats such as CSV (Comma Separated Value Format), XML (eXtensible Markup Language), and the like.

The dictionary storing unit 16 stores in the dictionary 12 data concerning the management and analysis of the tables stored in the database 11. The dictionary storing unit 16 stores information in the common dictionary 121 which is accessible by all the users. The dictionary storing unit 16 includes a personal dictionary storing unit 161, prepares the personal dictionary 122 in which only an authorized user can enter information into, refer to, and update information, and stores data concerning the management and analysis of the common table 111 and the personal table 112.

The personal dictionary storing unit 161 comprises a table information storing unit 161a, an operation data storing unit 161b, a link data storing unit 161c, a composite field information storing unit 161d, and a management point data register 161e.

The table information storing unit 161a stores in the personal dictionary 122 the data structure or data attribute of the personal table 112. The operation data storing unit 161b stores in the personal dictionary 122 the data concerning the operations performed on the common table 111 or the personal table 112. More specifically, an operational expression is set as a hypothetical field in the common table 111 and the personal table 112, and this information is stored/managed in the personal dictionary 122. The user can perform an operation by referring to the personal dictionary 122 and selecting the hypothetical field of operation.

The link data storing unit 161c stores in the personal dictionary 122 the information required for linking two personal tables 112 or a personal table. 112 and a common table 111. More specifically, the link data storing unit 161c stores in the personal dictionary 122 information such as the names of tables that are linked or a linking key field required when linking two tables.

The composite field information storing unit 161d stores in the personal dictionary 122 the information of composite fields formed by combining plural fields. The fields are combined when plural fields are related to each other. Thus, using the complex field for database search saves time and effort required for specifying fields individually. A composite field ‘Date’ for instance can be used by combining the fields ‘Year’, ‘Month’, and ‘Day’.

The management point data storing unit 161e stores in the personal dictionary 122 the information of a management point. The management point is where data concerning the method of the management or analysis of the data when performing multi-dimensional analysis of the data in the relational database 11 is set. For instance, the classification methodologies, such as area-wise, product-wise, time-wise sales data researching methods for checking the tendency of the sales of a product are set in the management point. As a result of this classification, the data in the database 11 can be managed and analyzed effectively.

When the user requests for the reference of the dictionary 12, the dictionary reference unit 17 gets the information stored in the common dictionary 121 or the personal dictionary 122, such as the operation data and the combined information, and then transmits this information to the user interface unit 11. When the user selects, from among the information displayed on the user interface unit 11, the information to be used for searching, the dictionary reference unit 17 accepts and transmits this selection to the searching unit 18.

When the user requests for a data search, the searching unit 18 searches the data in the database 11 by referring to the information of the dictionary 12. The searching unit 18 gets from the common dictionary 121 or the personal dictionary 122 the information which is selected by the user through the dictionary reference unit 17 and which is to be used for searching the database, and retrieves data based on this information.

If a new table is obtained as a result of data retrieval, and the user requests this table to be stored in the personal table 112, the searching unit 18 stores this new table as the personal table 112 through the personal table storing unit 151. The searching unit 18 then stores, through the personal table storing unit 151, the information pertaining to management of the new table in the personal dictionary 122.

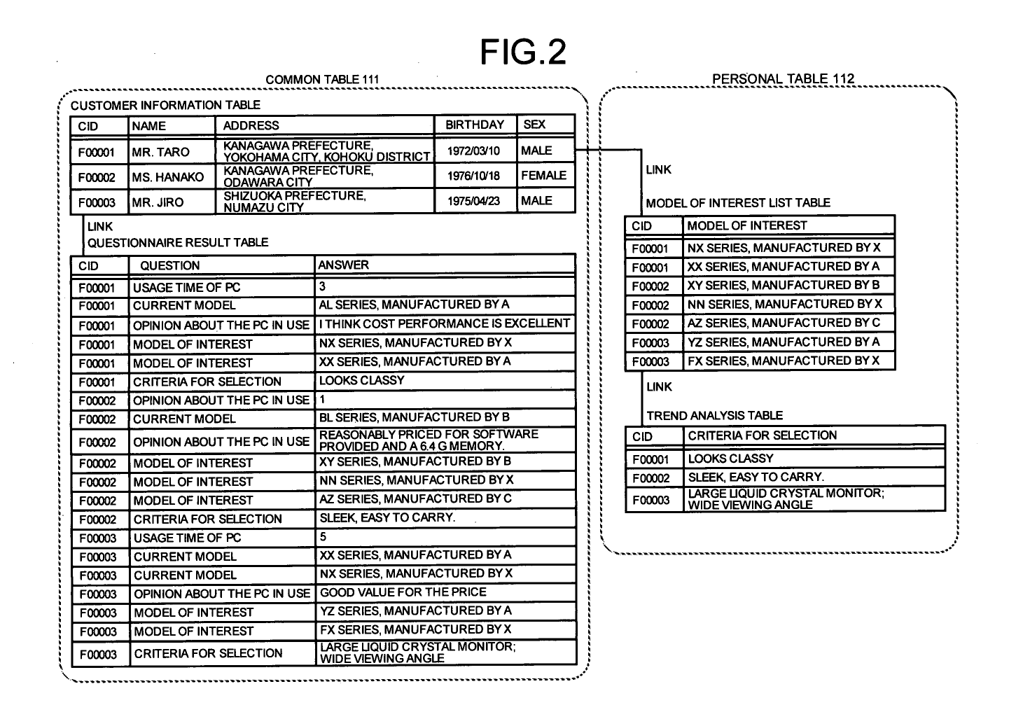

FIG. 2 is an example of a table structure of a common table 111 and a personal table 112 in a database 11. The common table 111 includes a customer information table and a questionnaire result table. The personal table 112 includes a model of interest list table and a trend analysis table.

The customer information table stores the customer's personal information data such as a customer ID, name, address, date of birth, and sex. The questionnaire result table stores on a personal computer (PC) response data to the questionnaire sent by each customer. The questionnaire result table includes the fields Customer ID, Question, and Response. The customer information table and the questionnaire result table are linked, with Customer ID as the key field.

When the user searches the database 11, the model of interest list table is obtained by extracting the content in the row ‘Model of interest’ from the Question field of the questionnaire result table of the common table 111, and storing the response as the model of interest list table in the form of a personal table 112. The model of interest list table includes the fields Customer ID and Model of interest. The model of interest list table and the customer information table are linked, with the field Customer ID as the key field.

When the user searches the database 11, the trend analysis table is obtained by extracting the content in the row ‘Criteria for selection’ from the Question field of the questionnaire result table of the common table 111, and storing the response as the trend analysis table in the form of the personal table 112. The trend analysis table includes the fields Customer ID and Criteria for selection. The trend analysis table and the model of interest list table are linked, with the field Customer ID as the key field.

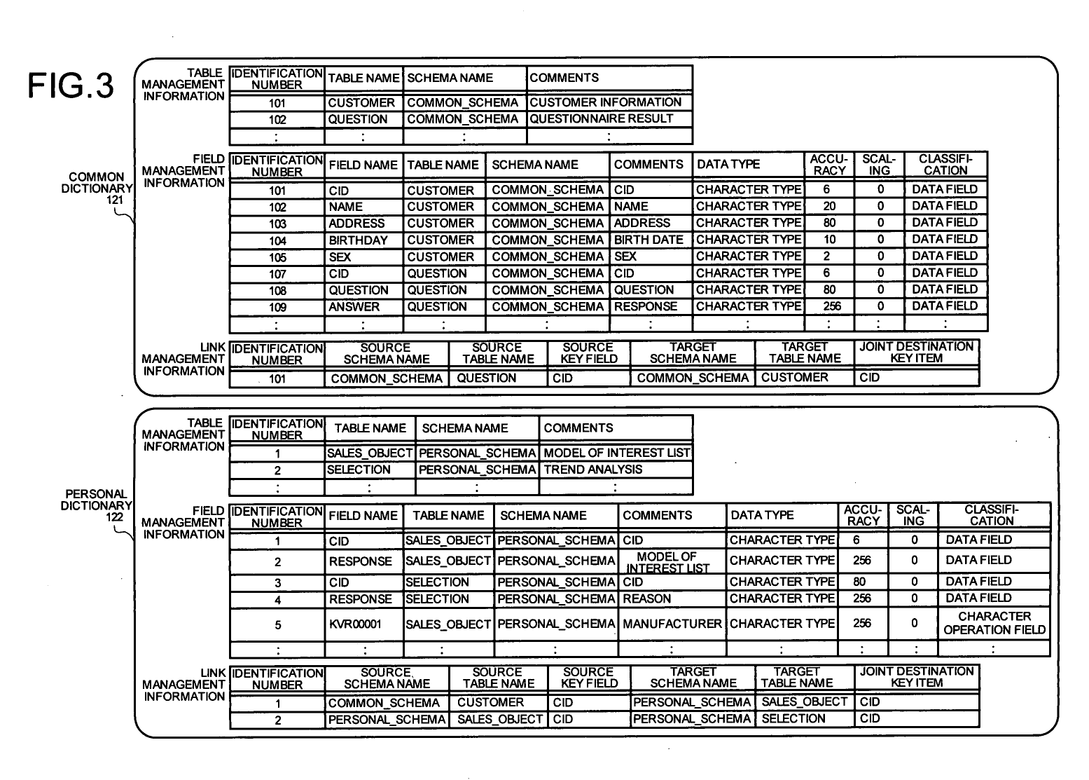

FIG. 3 is an example of a data structure of a common dictionary 121 and a personal dictionary 122 in a data dictionary 12. The common dictionary 121 includes information, such as table management information, field management information, and link management information, relating to the common table 111.

The table management information is a table that stores information which manages each table that is included in the common table 111. This table includes the fields Table identification number, Table name, Table schema name, and Comments. The field Schema name contains the names of the schema which constitute each table. The field Comments contains a brief description of each table which is identified by the identification number. In the present example, the information of the customer information table and the questionnaire result table in the common table 111 is shown.

The field management information is a table that stores the management information which manages the fields in each table. This table includes the fields Field identification number, Field name within the table, table name which includes the Field, Schema name of the table, Comment, Data type, Accuracy, Decimal scaling, and Classification. The field Comment contains description of each field which is identified by an identification number, and the field Data type describes the data type of the data stored in each field. The field Accuracy contains the number of bytes of the data of each field, and the field Decimal scaling stores the number of digits on the right side of the decimal point of a number of a numeric data type. In the present example, information of the customer information table and the questionnaire result table within the common table 111 is shown.

The link management information is a table that stores information for managing linking of two tables. This table includes the fields Link identification number for identifying link, Source schema name, Source table name, Source key field (indicating the key field for linking), Target schema name, Target table name, and Target key field (indicating the key field for linking). The present example shows the linking of the customer information table and the questionnaire result table within the common table 111 shown in FIG. 2. The user can link any two tables based on the link data and can easily obtain a new table.

The personal dictionary 122 comprises information, such as table management information, field management information, and link management information, relating to the personal table 112. As in the common dictionary 121, the table management information of the personal dictionary 122 is table that includes the fields Table identification number of table, Table name, Schema name, and Comments. In the present example, this table contains information of the model of interest list table and the trend analysis table within the personal table 112 shown in FIG. 2.

The field management information is a table that includes the fields Field identification number, Field name, Table name, Schema name, Comment, Data type, Accuracy, Decimal scaling, and classification. In the present example, this table contains the information of the fields of model of interest list table and a trend analysis table within the personal table 112 shown in FIG. 2.

The link management information is a table which stores information for managing the linking of two tables. This table includes the fields Link identification number for identifying link, Source schema name, Source table name, Source key field (indicating the key field for linking), Target schema name, Target table name, and Target key field (indicating the key field for linking). In the present example the customer information table within the common table 111 shown in FIG. 2, and the model of interest list table within the personal table 112 shown in FIG. 2 are linked, as are the model of interest dist table and the trend analysis table within the personal table 112 shown in FIG. 2.

So far, the personal dictionary 122 was shown to store information related to table management, field management, and link management. The personal diction 122 can also store data concerning the operation performed on the table, composite fields, management point, etc.

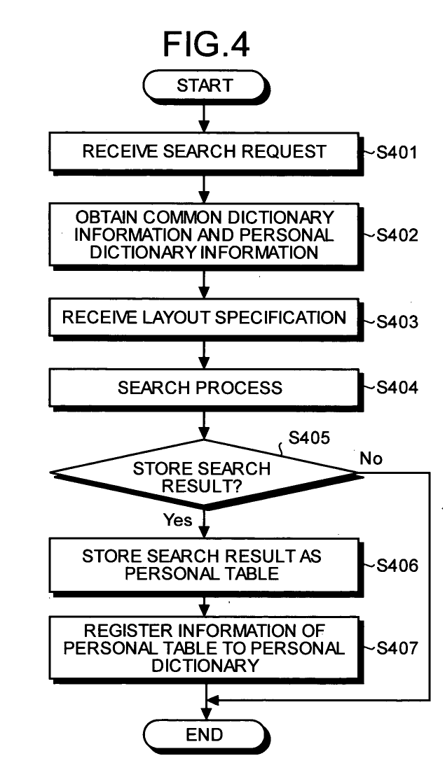

FIG. 4 is a flowchart of a procedure of database search according to the embodiment. A request for search of the database is received from the user (Step S401). Further, the data concerning the management/analysis of the operation, composite field, or management point, is obtained from the common dictionary 121 and the personal dictionary 122 (Step S402).

Next, the layout specification regarding the table format data to be presented as the search result is received from the user (Step S403). At the same time, selection of information related to the operation, composite field, or management point, which is used for the data search and which is stored in the common dictionary 121 and the personal dictionary 122 is also received from the user.

The searching of the database is carried out based on the received layout specification and the data concerning the operation, composite field, or management point, and the search result is obtained (Step S404). Specification is received regarding whether to store the search result table as the personal table 112 (Step S405). If the search result table is not to be stored as the personal table 112 (‘No’ in Step S405), the process ends there.

If the search result table is to be stored as the personal table 112 (‘Yes’ in Step S405), the search result table is stored in the database 11 as the personal table 112 (Step S406). The data concerning the management/analysis of the table stored as the personal table 112 is stored as the personal dictionary 122 in the dictionary 12 (Step S407).

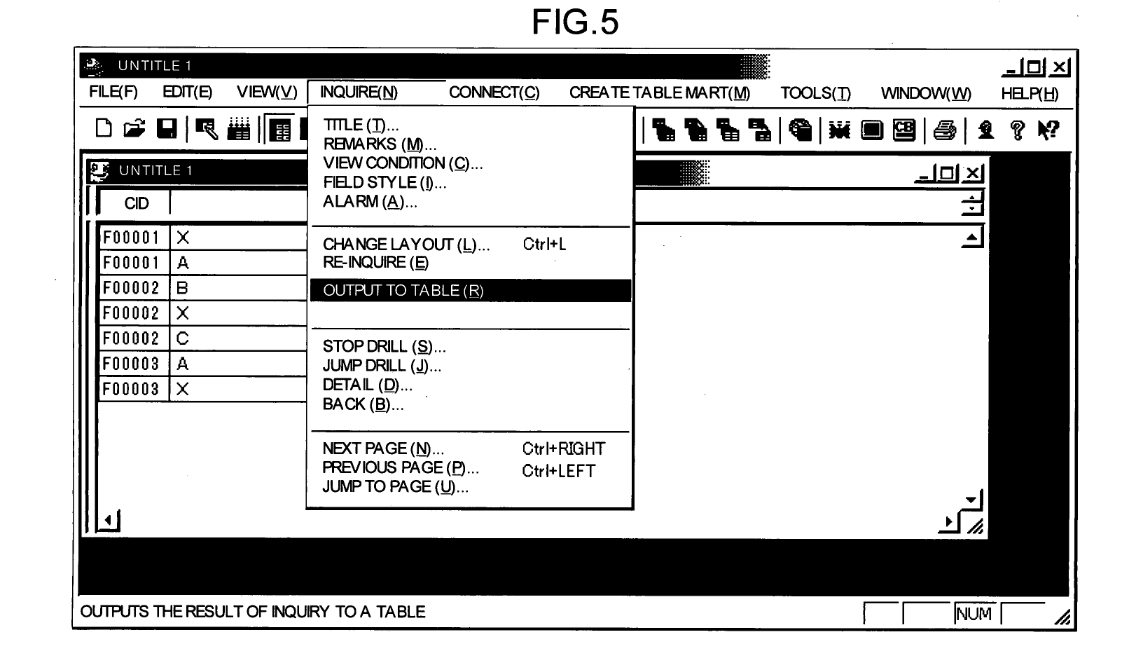

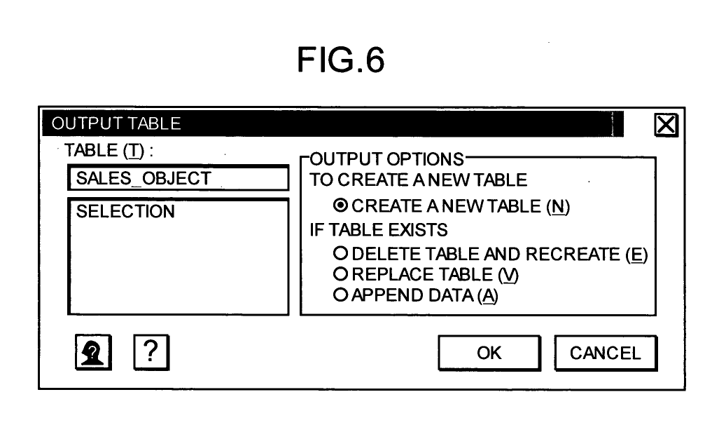

FIG. 5 is an example of a display screen when storing a search result as a personal table 112. FIG. 6 is an example of a display screen when “Export to table” menu shown in FIG. 5 is selected. Once the search result is obtained, the “Export to table” menu which, stores the search result as the personal table 112, is enabled. Upon selecting the “Export to table” menu the display screen as shown in FIG. 6. The search result can then be stored as the personal table 112 by specifying the table name (SALES_OBJECT).

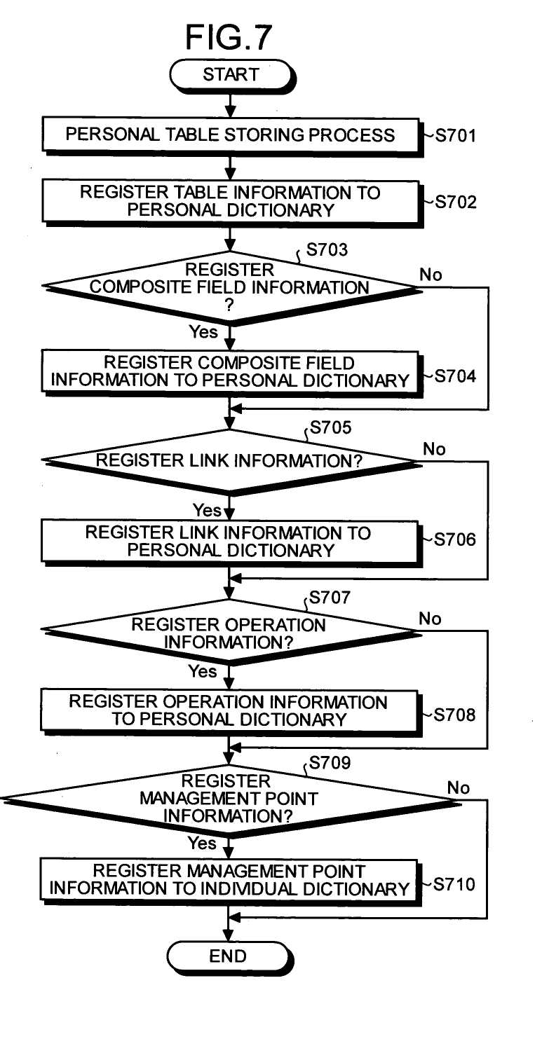

FIG. 7 is a flowchart of a procedure of registering information in the personal table 112 to the personal dictionary 122 shown in FIG. 4. After storing the search result as the personal table 112 (Step S701), the personal dictionary storing unit 161 stores in the personal dictionary 122 the structure and attribute information entered in the personal table 112 (Step S702).

Next, the personal dictionary storing unit 161 checks if complex field information is to be stored in the personal dictionary 122 (Step S703). If the composite field information is to be stored (‘Yes’ in step S703) in the personal dictionary 122, the composite field information storing unit 161d stores the composite field information in the personal table 112 (Step S704). If not (‘No’ in step S703), the process proceeds to step S705.

Next, the personal dictionary storing unit 161 checks if link data is to be stored in the personal dictionary 122 (Step S705). If the link data is to be stored (‘Yes’ in step S705), the link data storing unit 161c stores the link data in the personal table 112 (Step S706). If not (‘No’ in step S705), the process proceeds to step S707.

Next, the personal dictionary storing unit 161 checks if operation data is to be stored in the personal dictionary 122 (Step S707). If the operation data is to be stored in the personal dictionary 122 (‘Yes’ in step S707), the operation data storing unit 161b stores the operation data in the personal table 112 (Step S708). If not (‘No’ in step S707), the process proceeds to step S709.

Next, the personal dictionary storing unit 161 checks if management point data is to be stored in the personal dictionary 122 (Step S709). If the management point data is to be stored in the personal dictionary 122 (‘Yes’ in step S709), the management point data storing unit 161e stores the management point data in the personal table 112 (Step S710). If not, (‘No’ in step S709), the process ends there.

Storing of all the four types of information, namely, the composite field information, link data, operation data, and management point data, has been described so far. However, any of these types of information may be stored upon request such a request by the user. Apart from the types of information described here, various other types of data concerning the management and analysis of the common table 111 and the personal table 112 can also be stored in the personal dictionary 122.

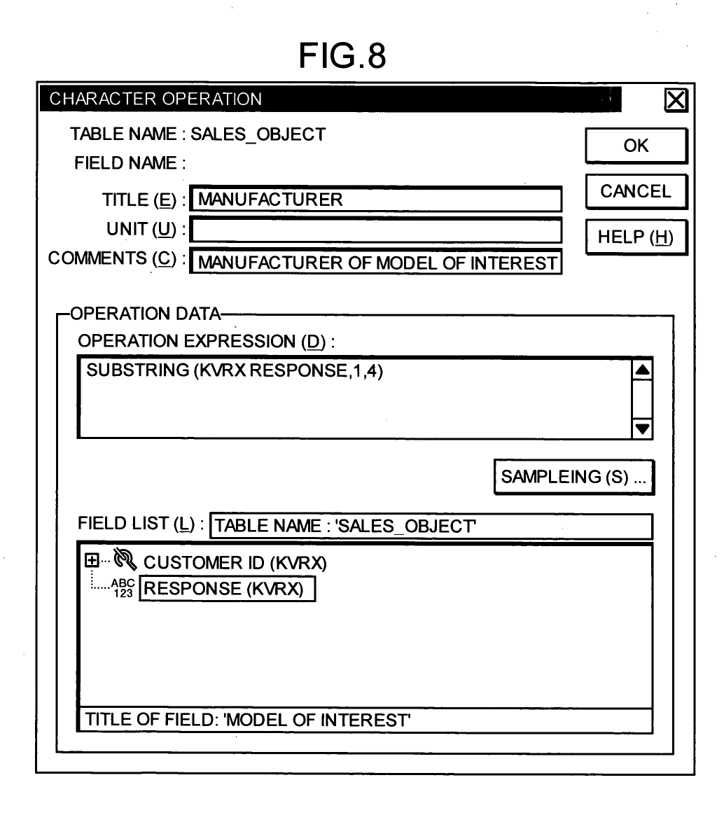

FIG. 8 is an example of a display screen when registering operation data to the personal dictionary 122. Each operational expression has a title, and by selecting the heading, the relevant operational expression can be called and thereby efficient search of the desired data can be carried out. In the example shown in FIG. 8, the operational expression (SUBSTRING) extracts the manufacturer of the model of interest from the model of interest list table shown in FIG. 2.

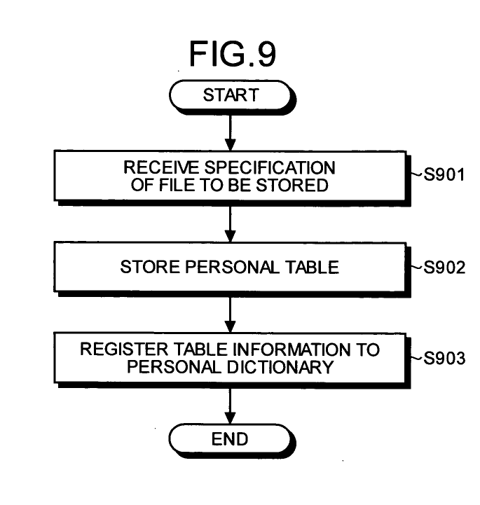

FIG. 9 is a flowchart of a procedure of storing data having a predetermined file format, such as CSV, XML, etc., to the personal table 112. The user interface unit 13 receives the specification of the data having a predetermined file format that is to be stored in the personal table 112 (Step S901).

The file storing unit 152 stores as the personal table 112 the data having the predetermined file format (Step S902). Next, the personal dictionary storing unit 161 stores as the personal dictionary 122 (Step S903). More specifically, steps S702 through S710 shown in FIG. 7 are repeated for the personal dictionary 122.

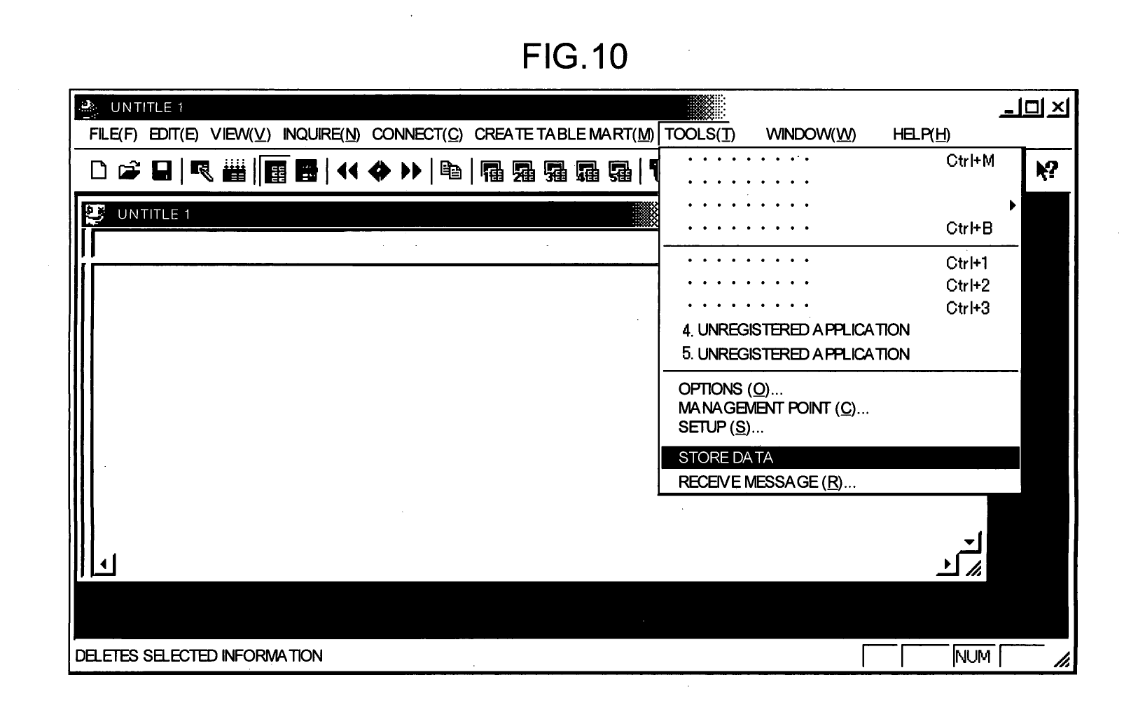

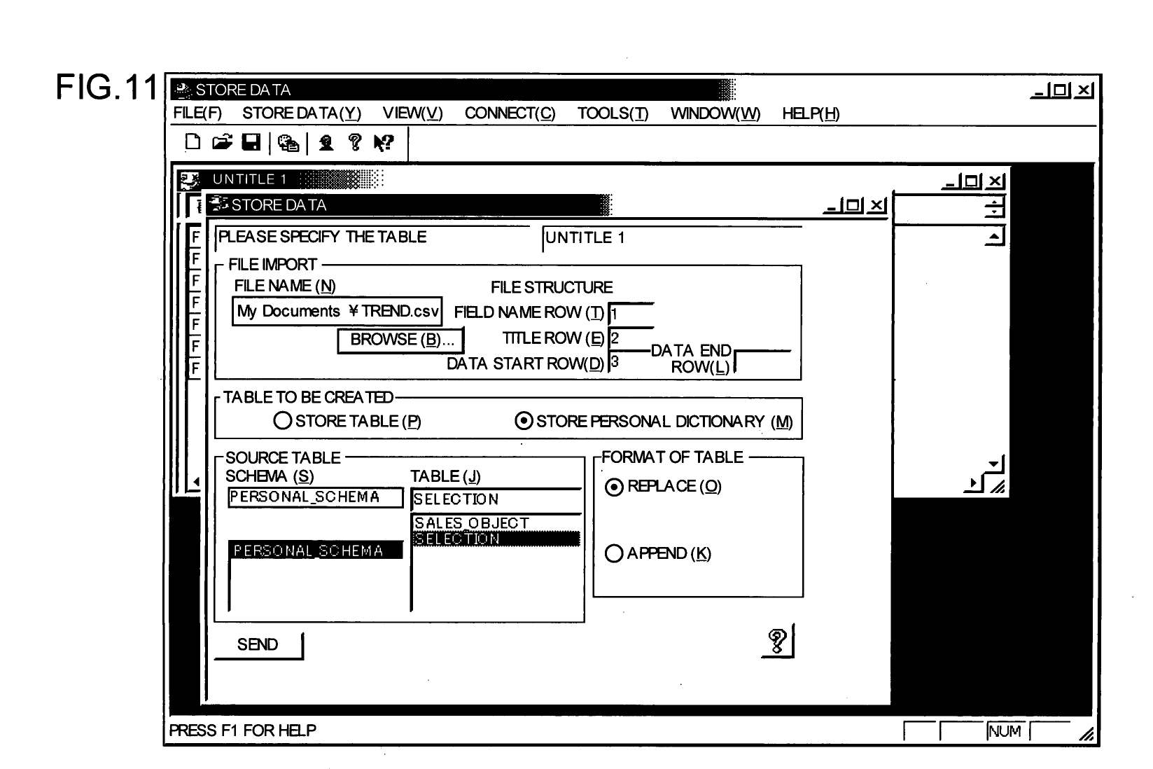

FIG. 10 is an example of a display screen when storing the data having the predetermined file format to the personal table 112. FIG. 11 is an example of a display screen when “Store data” menu shown in FIG. 10 is selected. When the “Store data” menu is selected the data having a predetermined file format is stored as the personal table 112 and a data storing screen appears as shown in FIG. 11. By entering in the data storing screen the name of the data (trend csv) to be stored as the personal table 112 and the name of the personal file 112 (SELECTION) into which the data is to be stored, and clicking the ‘Send’ button, the specified data is stored in the personal table 112 of the specified name. Once the specified data is stored in the personal table 112, the data concerning the management and analysis of the personal table is entered in the personal dictionary 122.

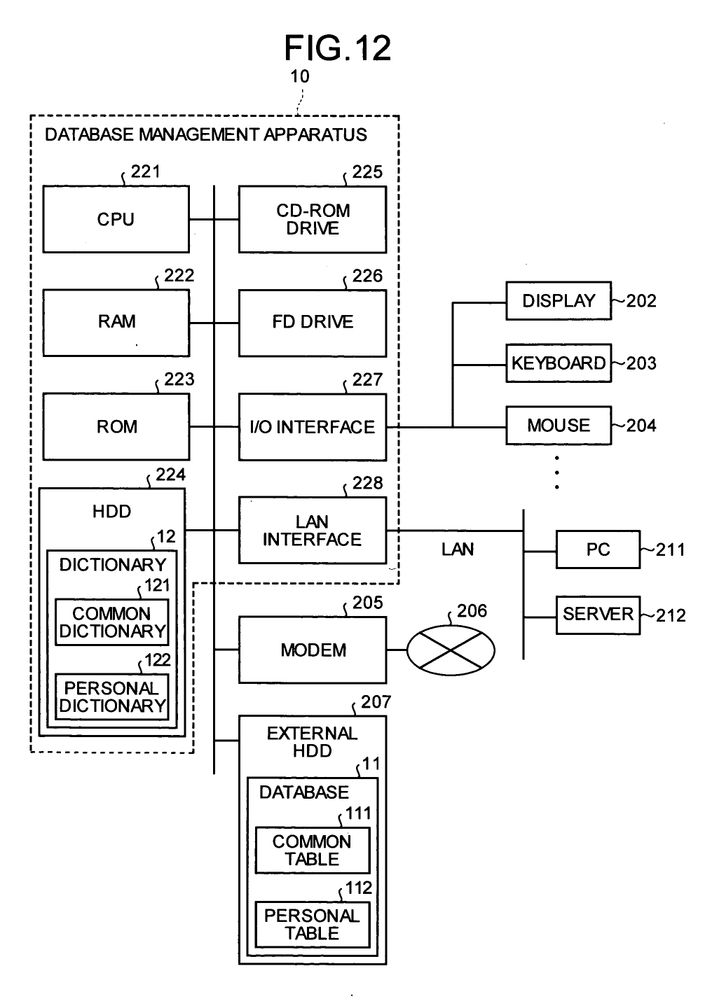

FIG. 12 is a block diagram for illustrating a hardware configuration of the database management apparatus 10. The database management apparatus 10 according to the present invention is provided with a display 202 for displaying the information such as the instructions from the database management apparatus 10, a keyboard 203 for entering various information in the database management apparatus 10, and a mouse 204 for pointing to any position on the display screen of the display 202.

The database management apparatus is provided with a central processing unit (CPU) 221, a read only memory (ROM) 222, a random access memory (RAM) 223, a harddisk drive (HDD) 224, a CD ROM drive 225 which receives a CD ROM, a flexible disk (FD) drive 226 which receives a flexible disk, an I/O interface 227 which connects the display 202, the keyboard 203, and the mouse 204, and a local area network (LAN) interface 228 connected to a LAN or a Wide Area Network (WAN). The hard disk drive 224 stores as the dictionary 12 the common dictionary 121 and the individual dictionary 122.

The database management apparatus 10 is connected to a public circuit 206 through a modem 205 and to another personal computer (PC) 211, a server 212, etc. through the LAN interface 228 and the LAN/WAN. An external HDD, which stores the common table 111 and the personal table 112 as a relational database 11, is connected to the database management apparatus 10.

The database management apparatus 10 realizes the data management functions by reading and executing the database management programs recorded in a designated recording medium. The recording medium may include a ‘portable’ type in the form of FD, CD-ROM, magneto-optical (MO) disk, digital versatile disk (DVD), IC card, etc., or a ‘fixed’ type in the form of HDD 224 integral to the database management apparatus 10 or provided externally, RAM 222, ROM 223, etc., or a ‘communication medium’ in the form of a public circuit 206 connected through the modem 205 or LAN/WAN 206 by which the database management apparatus 10 is connected to another computer system 211 and the server 212 and which stores the transmitted program for a short duration.

In other words, the programs for database management are stored in the ‘portable’ medium, ‘fixed’ medium or ‘communication medium’ described above in a readable manner, and the database management apparatus 10 executes these programs by reading the programs stored in the recording medium. Apart from the database management apparatus 10, the programs for database management can also be executed by another computer system 211 or the server 212 or jointly by another computer system 211 and the server 212.

Thus, according to the present embodiment, the data concerning the management/analysis such as link data or operation data of the common table 111 or the personal table 112 stored in the database 11 is stored as the personal dictionary 122 which can be used only be an authorized user. When a request is received for reference of the personal dictionary 122 and the common dictionary 121, the information stored in the personal dictionary 122 and the common dictionary 121 is output. A search of the database is carried out based on the information, such as the link data or operation data, selected by the user from among the output information. Thus, the user can store various information required for searching in the personal dictionary 122 which allows the user to freely store or update information. Consequently, data can be searched efficiently using the personal dictionary 122 and the common dictionary 121.

All the automatic processes explained in the present embodiment can be entirely or in part carried out manually. Similarly, all the manual processes explained in the present embodiment can be entirely or in part carried out automatically. The sequence of processes, the sequence of controls, specific names, and data including various parameters can be changed as required unless otherwise specified The constituent elements of the apparatus illustrated are merely conceptual and may not necessarily physically resemble the structures shown in the drawings. For instance, the apparatus (the database management apparatus) need not necessarily have the structure that is illustrated. The apparatus as a whole or in parts can be broken down or integrated either functionally or physically in accordance with the load or how the apparatus is to be used. The process functions of the apparatuses can be wholly or partially realized by the CPU or a program run by the CPU or can be realized by hardware through wired logic.

Thus, according to the present invention, the user can freely add to and update the data concerning the management and/or analysis of the data in the database, and can carry out efficient data search on the database using the information stored in the dictionary which includes the personal dictionary.

Further, according to the present invention, the user can freely add to and update the data concerning the management and/or analysis of the search data in the database, and can carry out efficient data search on the database using the information stored in the dictionary which includes the personal dictionary.

Moreover, according to the present invention, the user can freely add to and update the data concerning the management and/or analysis of the data having the predetermined format in the database, and can carry out efficient data search on the database using the information stored in the dictionary which includes the personal dictionary.

Further, according to the present invention, the user can freely add to and update the data concerning the management and/or analysis of the operation data, and can carry out efficient data search on the database using the information stored in the dictionary which includes the personal dictionary.

Moreover, according to the present invention, the user can freely add to and update the data concerning the management and/or analysis of the link data, and can carry out efficient data search on the database using the information stored in the dictionary which includes the personal dictionary.

Further, according to the present invention, the user can freely add to and update the information data the management and/or analysis of the composite field, and can carry out efficient data search on the database using the information stored in the dictionary which includes the personal dictionary.

Moreover, according to the present invention, the user can freely add to and update the data concerning the management and/or analysis of the management point data, and can carry out efficient data search on the database using the information stored in the dictionary, which includes the personal dictionary.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A database management apparatus that performs a search of data from a database based on predetermined information selected by a user from among information registered as a dictionary, the database management apparatus comprising:
a personal dictionary registering unit that registers information on either of or both management and analysis of the data stored in the database to the dictionary as a personal dictionary that is accessible only by a predetermined user; and
a dictionary reference unit that outputs the information registered in the dictionary including the information registered as the personal dictionary, and accepts a selection of the predetermined information by the user from among the information output.

2. The database management apparatus according to claim 1, further comprising:
a personal table storing unit that stores data obtained as a result of the search, wherein
the personal dictionary registering unit registers information on either of or both management and analysis of the data stored at the personal table storing unit as the personal dictionary that is accessible only by a user who made a request for the search.

3. The database management apparatus according to claim 1, further comprising:
a file storing unit that stores, upon the database management apparatus receiving a request to store data having a predetermined file format, the data having the predetermined file format to the database, wherein
the personal dictionary registering unit registers information on either of or both management and analysis of the data stored by the file storing unit as the personal dictionary that is accessible only by a user who made the request.

4. The database management apparatus according to claim 1, wherein
the personal dictionary registering unit registers, upon the database management apparatus receiving a request to register information on a predetermined operation applied to the data of the database, the information on the predetermined operation to the personal dictionary that is accessible only by a user who made the request, and
the dictionary reference unit outputs the information registered in the dictionary including the information on the predetermined operation registered, and accepts the selection of the predetermined information by the user from among the information output.

5. The database management apparatus according to claim 1, wherein
the personal dictionary registering unit registers, upon the database management apparatus receiving a request to register information on a link between the data of the database, the information on the link to the personal dictionary that is accessible only by a user who made the request, and
the dictionary reference unit outputs the information registered in the dictionary including the information on the link registered, and accepts the selection of the predetermined information by the user from among the information output.

6. The database management apparatus according to claim 1, wherein
the personal dictionary registering unit registers, upon the database management apparatus receiving a request to register information on a composite field that is formed by combining a plurality of data fields of the database, the information on the composite field to the personal dictionary that is accessible only by a user who made the request, and
the dictionary reference unit outputs the information registered in the dictionary including the information on the composite field registered, and accepts the selection of the predetermined information by the user from among the information output.

7. The database management apparatus according to claim 1, wherein
the personal dictionary registering unit registers, upon the database management apparatus receiving a request to register management point information on either of or both management and analysis of the data stored in the database, management point information to the personal dictionary that is accessible only by a user who made the request, and
the dictionary reference unit outputs the information registered in the dictionary including the management point information registered, and accepts the selection of the predetermined information by the user from among the information output.

8. A database management method to perform a search of data from a database based on predetermined information selected by a user from among information registered as a dictionary, the database management method comprising:
registering information on either of or both management and analysis of the data stored in the database to the dictionary as a personal dictionary that is accessible only by a predetermined user;
outputting the information registered in the dictionary including the information registered as the personal dictionary; and
acceptting a selection of the predetermined information by the user from among the information output.

9. The database management method according to claim 8, further comprising:
storing data obtained as a result of the search, wherein
the registering includes registering information on either of or both management and analysis of the data stored as the personal dictionary that is accessible only by a user who made a request for the search.

10. The database management method according to claim 8, further comprising:
storing, upon receiving a request to store data having a predetermined file format, the data having the predetermined file format to the database, wherein
the registering includes registering information on either of or both management and analysis of the data stored as the personal dictionary that is accessible only by a user who made the request.

11. The database management method according to claim 8, wherein
the registering includes registering, upon receiving a request to register information on a predetermined operation applied to the data of the database, the information on the predetermined operation to the personal dictionary that is accessible only by a user who made the request,
the outputting includes outputting the information registered in the dictionary including the information on the predetermined operation registered, and
the accepting includes accepting the selection of the predetermined information by the user from among the information output.

12. The database management method according to claim 8, wherein
the registering includes registering, upon receiving a request to register information on a link between the data of the database, the information on the link to the personal dictionary that is accessible only by a user who made the request,
the outputting includes outputting the information registered in the dictionary including the information on the link registered, and
the accepting includes accepting the selection of the predetermined information by the user from among the information output.

13. The database management method according to claim 8, wherein
the registering includes registering, upon receiving a request to register information on a composite field that is formed by combining a plurality of data fields of the database, the information on the composite field to the personal dictionary that is accessible only by a user who made the request,
the outputting includes outputting the information registered in the dictionary including the information on the composite field registered, and
the accepting includes accepting the selection of the predetermined information by the user from among the information output.

14. The database management method according to claim 8, wherein
the registering includes registering, upon receiving a request to register management point information on either of or both management and analysis of the data stored in the database, management point information to the personal dictionary that is accessible only by a user who made the request,
the outputting includes outputting the information registered in the dictionary including the management point information registered, and
the accepting includes accepting the selection of the predetermined information by the user from among the information output.

15. A computer program for managing a database to perform a search of data from a database based on predetermined information selected by a user from among information registered as a dictionary, the computer program making a computer execute:
registering information on either of or both management and analysis of the data stored in the database to the dictionary as a personal dictionary that is accessible only by a predetermined user;
outputting the information registered in the dictionary including the information registered as the personal dictionary; and
acceptting a selection of the predetermined information by the user from among the information output.

16. The computer program according to claim 15, further making a computer execute:
storing data obtained as a result of the search, wherein
the registering includes registering information on either of or both management and analysis of the data stored as the personal dictionary that is accessible only by a user who made a request for the search.

17. The computer program according to claim 15, further making a computer execute:
storing, upon receiving a request to store data having a predetermined file format, the data having the predetermined file format to the database, wherein
the registering includes registering information on either of or both management and analysis of the data stored as the personal dictionary that is accessible only by a user who made the request.

18. A computer-readable recording medium for storing a computer program for realizing a database management, the computer program making a computer execute:
registering information on either of or both management and analysis of the data stored in the database to the dictionary as a personal dictionary that is accessible only by a predetermined user;
outputting the information registered in the dictionary including the information registered as the personal dictionary; and
acceptting a selection of the predetermined information by the user from among the information output.
